(19) United States
(12) Patent Application Publication
(10) Pub. No.: US 2016/0061249 A1
(43) Pub. Date: Mar. 3, 2016

(54) ADJUSTABLE SHEAR KEY

(71) Applicant: Douglas H. Powell, Eldorado Hills, CA (US)

(72) Inventor: Douglas H. Powell, Eldorado Hills, CA (US)

(21) Appl. No.: 14/473,921

(22) Filed: Aug. 29, 2014

(51) Int. Cl. F16B 31/02

(52) U.S. Cl. CPC F16B 31/021

(57) ABSTRACT

An adjustable shear key for connecting a first element to a second element. The adjustable shear key includes a body. The body includes a first portion configured to mate with a keyseat in a first element and a second portion configured to mate with a keyway in a second element. The body is configured to prevent relative motion in at least one direction of the first element relative to the second element. The adjustable shear key also includes a designed flaw passing through the body, where the alignment of the designed flaw is parallel to the interface of the first element and the second element. The designed flaw is configured to allow the body to shear at a predetermined shear force.

### CROSS-REFERENCE TO RELATED APPLICATIONS

Not applicable.

### BACKGROUND OF THE INVENTION

Shear keys are used to restrict relative motion between two parts. I.e., they ensure that two parts rotate or move at the same rate as one another. They are designed to break the connection between the two parts when one of the parts is overloaded. I.e., when the speed of rotation, speed of movement, toque or force would tend to damage one of the parts the shear key breaks, severing the connection allowing relative motion between the two parts. Thus, more expensive parts or systems can be spared in the case of a failure, limiting damage to parts that are easier or cheaper to replace.

However, shear keys tend to have limited adjustability. That is, the force at which the shear key will shear is almost exclusively determined by the material from which it is constructed and its limited standard dimensions. Thus, the choices tend to be relatively limited and other tradeoffs must be accommodated. For example, in a given mechanical system a shear key which is below the desired threshold must be chosen (otherwise shearing will not prevent damage) but it may be far below the actual desired threshold.

This may lead to situations where shear keys have to be replaced even though the force did not reach a level where damage would have occurred. Therefore, choosing a shear key that is too far below the desired threshold may be likewise detrimental as it leads to excessive repair and “downtime” for machinery.

Accordingly, there is a need in the art for a shear key in which the threshold at which shearing will occur may be adjusted. Further, there is a need in the art for the shear key to accommodate various keyed joints.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes an adjustable shear key for connecting a first element to a second element. The adjustable shear key includes a body. The body includes a first portion configured to mate with a keyseat in a first element and a second portion configured to mate with a keyway in a second element. The body is configured to prevent relative motion in at least one direction of the first element relative to the second element. The adjustable shear key also includes a designed flaw passing through the body, where the alignment of the designed flaw is parallel to the interface of the first element and the second element. The designed flaw is configured to allow the body to shear at a predetermined shear force.

Another example embodiment includes a keyed joint. The keyed joint includes a first element, where the first element includes a keyseat and a second element, where the second element includes a keyway. The keyed joint also includes an adjustable shear key for connecting a first element to a second element. The adjustable shear key includes a body. The body includes a first portion configured to mate with a keyseat in the first element and a second portion configured to mate with a keyway in the second element. The body is configured to prevent relative motion of the first element relative to the second element. The adjustable shear key also includes a designed flaw passing through the body, wherein the alignment of the designed flaw is parallel to the interface of the first element and the second element. The designed flaw is configured to allow the body to shear at a predetermined shear force.

Another example embodiment includes a keyed joint. The keyed joint includes a shaft, where the shaft includes a keyseat and a rotating element, where the rotating element includes a keyway. The keyed joint also includes an adjustable shear key for connecting a shaft to a rotating element. The adjustable shear key includes a body. The body includes a first portion configured to mate with a keyseat in the shaft and a second portion configured to mate with a keyway in the rotating element. The body is configured to prevent relative motion of the shaft relative to the rotating element. The adjustable shear key also includes a series of designed flaws passing through the body, wherein the alignment of each of the designed flaws is parallel to the tangent of the interface of the shaft and the rotating element. The series of designed flaws is configured to allow the body to shear at a predetermined shear force.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1A is a perspective view of the example of a keyed joint;

FIG. 1B is a partial cut-away view of the example of a keyed joint;

FIG. 1C is an exploded view of the example of a keyed joint;

FIG. 1D is a side view of the example of a keyed joint (with the dashed lines representing hidden edges);

FIG. 1E is a cross-section view of the example of a keyed joint along the line A-A of FIG. 1D;

FIG. 1F is an end view of the example of a keyed joint;

FIG. 1G is a cross-section view of the example of a keyed joint along the line B-B of FIG. 1F;

FIG. 2A illustrates a perspective view of the example of an adjustable shear key;

FIG. 2B illustrates a side view of the example of an adjustable shear key;

FIG. 3A illustrates a perspective view of the example of an adjustable shear key which has been sheared;

FIG. 3B illustrates a side view of the example of an adjustable shear key which has been sheared;

FIG. 4A is a perspective view of the alternative example of a keyed joint;

FIG. 4B is a partial cut-away view of the alternative example of a keyed joint;

FIG. 4C is an exploded view of the alternative example of a keyed joint;

FIG. 4D is a side view of the alternative example of a keyed joint (with the dashed lines representing hidden edges);

FIG. 4E is a cross-section view of the alternative example of a keyed joint along the line A-A of FIG. 4D;

FIG. 4F is an end view of the alternative example of a keyed joint;

FIG. 4G is a cross-section view of the alternative example of a keyed joint along the line B-B of FIG. 4F;

FIG. 5A illustrates a perspective view of the example of an adjustable woodruff key;

FIG. 5B illustrates a side view of the example of an adjustable woodruff key;

FIG. 6A illustrates a perspective view of the example of an adjustable woodruff key which has been sheared;

FIG. 6B illustrates a side view of the example of an adjustable woodruff key which has been sheared;

FIG. 7A is a perspective view of the example of a planar keyed joint;

FIG. 7B is a partial cut-away view of the example of a planar keyed joint;

FIG. 7C is an exploded view of the example of a planar keyed joint;

FIG. 7D is a side view of the example of a planar keyed joint (with the dashed lines representing hidden edges);

FIG. 7E is a cross-section view of the example of a planar keyed joint along the line E-E of FIG. 7D;

FIG. 7F is an end view of the example of a planar keyed joint;

FIG. 7G is a cross-section view of the example of a planar keyed joint along the line F-F of FIG. 7F;

FIG. 8A illustrates a perspective view of the example of an adjustable shear key which has been sheared during use in a planar keyed joint; and

FIG. 8B illustrates a side view of the example of an adjustable shear key which has been sheared during use in a planar keyed joint.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

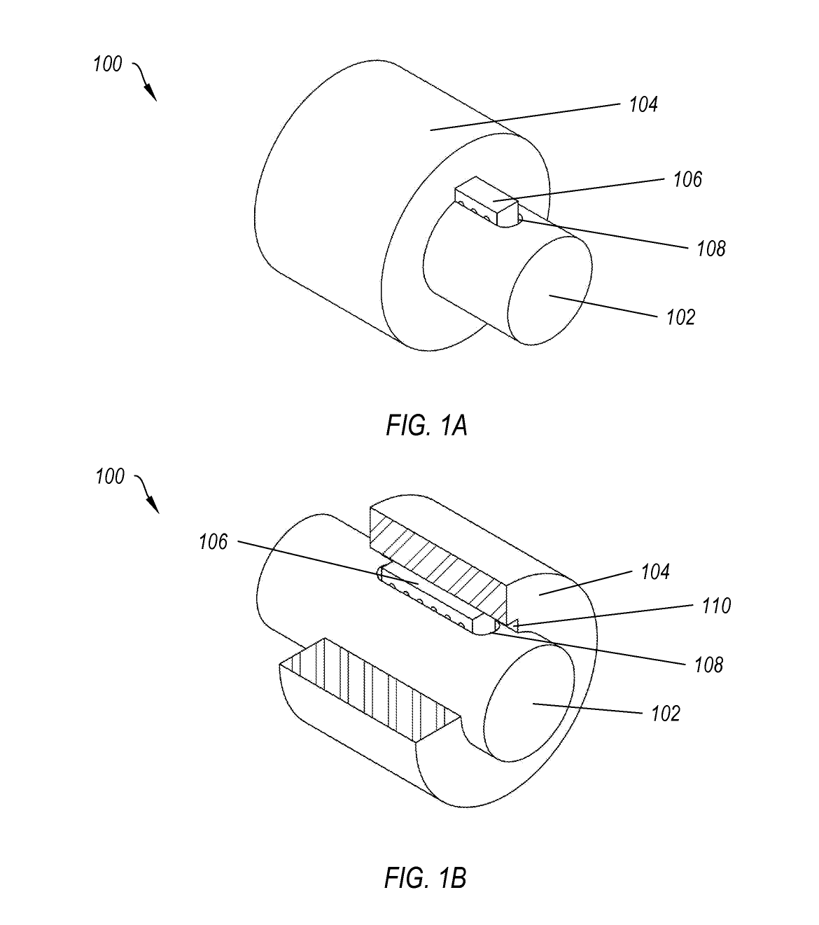

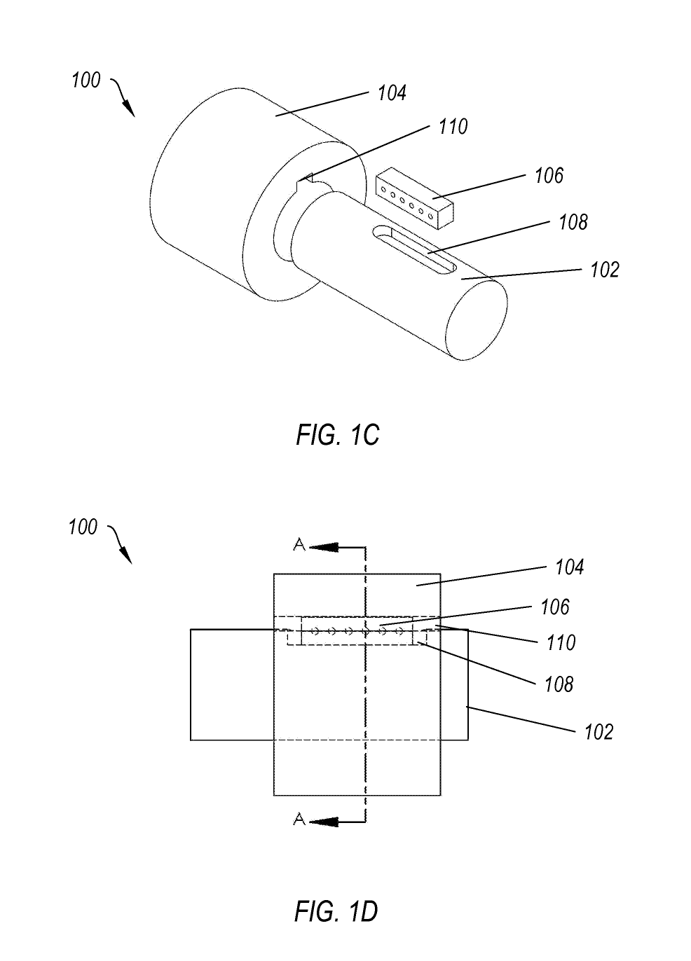

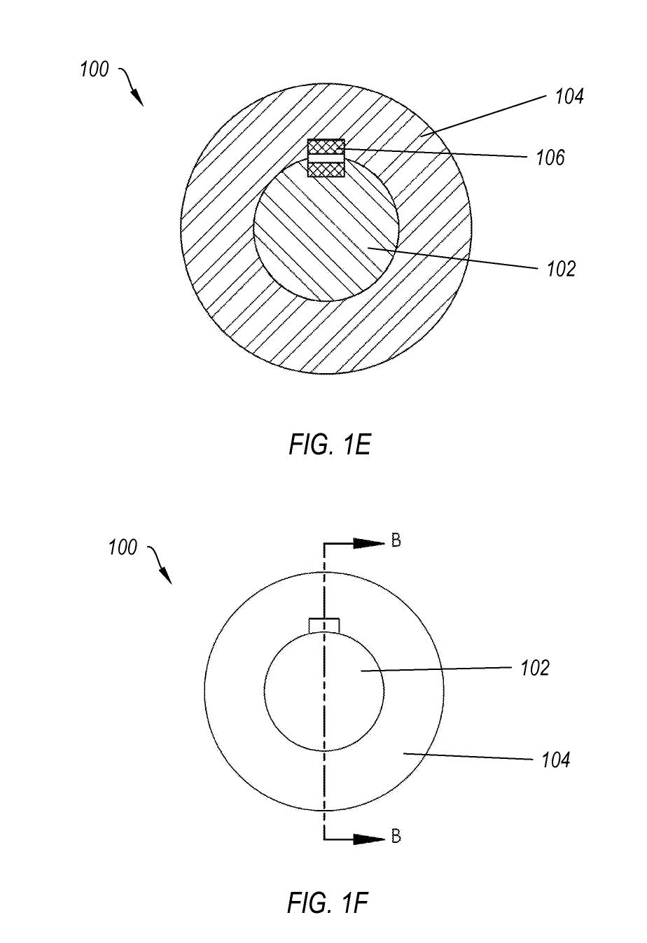

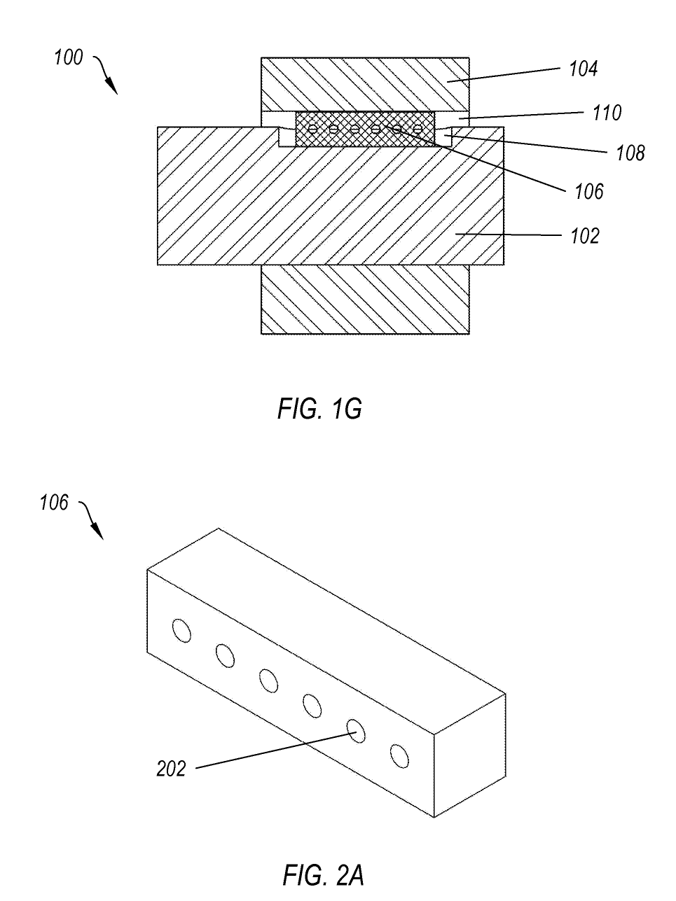

FIGS. 1A-1G (collectively “FIG. 1”) illustrate an example of a keyed joint 100. FIG. 1A is a perspective view of the example of a keyed joint 100; FIG. 1B is a partial cut-away view of the example of a keyed joint 100; FIG. 1C is an exploded view of the example of a keyed joint 100; FIG. 1D is a side view of the example of a keyed joint 100 (with the dashed lines representing hidden edges); FIG. 1E is a cross-section view of the example of a keyed joint 100 along the line A-A of FIG. 1D; FIG. 1F is an end view of the example of a keyed joint 100; and FIG. 1G is a cross-section view of the example of a keyed joint 100 along the line B-B of FIG. 1F. A keyed joint 100 is a joint which allows two elements to move in concert with one another. I.e., motion of the first element 102 induces motion in the second element 104 in one direction and vice versa. For example, a keyed joint 100 that prevents relative rotation between the two elements may enable torque transmission; however, the keyed joint 100 may allow relative axial movement between the parts. That is, the elements are free to undergo non-rotational movements relative to one another.

FIG. 1 shows that the keyed joint 100 can include a first element 102. The first element 102 may be a device capable of rotation, such as a shaft. A shaft is a long, generally cylindrical, bar that rotates and transmits power (e.g., the drive shaft of an engine). I.e., the shaft is a bar that undergoes rotation when torque is applied to the bar. A drive shaft (aka driveshaft, driving shaft, propeller shaft, prop shaft, or Cardan shaft) is a mechanical component for transmitting torque and rotation, usually used to connect other components of a drive train that cannot be connected directly because of distance or the need to allow for relative movement between them. As torque carriers, drive shafts are subject to torsion and shear stress, equivalent to the difference between the input torque and the load. They must therefore be strong enough to bear the stress, whilst avoiding too much additional weight as that would in turn increase their inertia.

FIG. 1 also shows that the keyed joint 100 can include a second element 104. The second element 104 can include any device that is configured to induce motion in, or have motion induced by, the first element 102. For example, in a rotating keyed joint 100 the second element 104 can include a rotating element such as a gear, wheel or any other apparatus. As used in the specification and the claims, the phrase “configured to” denotes an actual state of configuration that fundamentally ties recited elements to the physical characteristics of the recited structure. As a result, the phrase “configured to” reaches well beyond merely describing functional language or intended use since the phrase actively recites an actual state of configuration.

FIG. 1 moreover shows that the keyed joint 100 can include an adjustable shear key 106. The adjustable shear key 106 prevents relative motion between the first element 102 and the second element 104 (i.e., eliminates one degree of freedom of the second element 104 relative to the first element 102). That is, the adjustable shear key 106 transmits force such that motion of the first element 102 results in a matching motion of the second element 104 and vice versa. However, because the adjustable shear key 106 does not prevent all motion the first element 102 can be removed from the center of the second element 104. That is, external element(s) may keep the first element 102 and the second element 104 in alignment with one another and when the external element(s) are removed the first element 102 can be removed from the second element 104.

The adjustable shear key 106 of FIG. 1 is a parallel key. Parallel keys have a square or rectangular cross-section (i.e., as viewed in FIG. 1E). For example, Square keys may be used for smaller shafts and rectangular faced keys may be used for shaft diameters over 6.5 in (170 mm) or when the wall thickness of the second element 104 is an issue. Set screws often accompany parallel keys to lock the mating parts into place. Although the adjustable shear key 106 of FIG. 1 is a parallel key, this is exemplary of other adjustable shear keys 106 and other shapes are possible, and even desirable in certain circumstances.

FIG. 1 further shows that the keyed joint 100 can include a keyseat 108 in the first element 102. The keyseat 108 is configured to receive a portion of the adjustable shear key 106. In particular, the keyseat 108 matches a portion of the adjustable shear key 106 such that the adjustable shear key remains within the keyseat 108 even when the first element 102 is subject to force by the motion of the first element 102. One of skill in the art will appreciate that the keyed joint 100 can include multiple keyseats 108. For example, the keyed joint 100 can include 2, 3 or 4 keyseats, each with a matching adjustable shear key 106 to provide a more robust connection.

FIG. 1 additionally shows that the keyed joint 100 can include a keyway 110 in the second element 104. The keyway 110 is configured to receive a portion of the adjustable shear key 106. In particular, the keyway 110 matches a portion of the adjustable shear key 106 such that the adjustable shear key remains within the keyway 110 even when the second element 104 is subject to force by the motion of the first element 102.

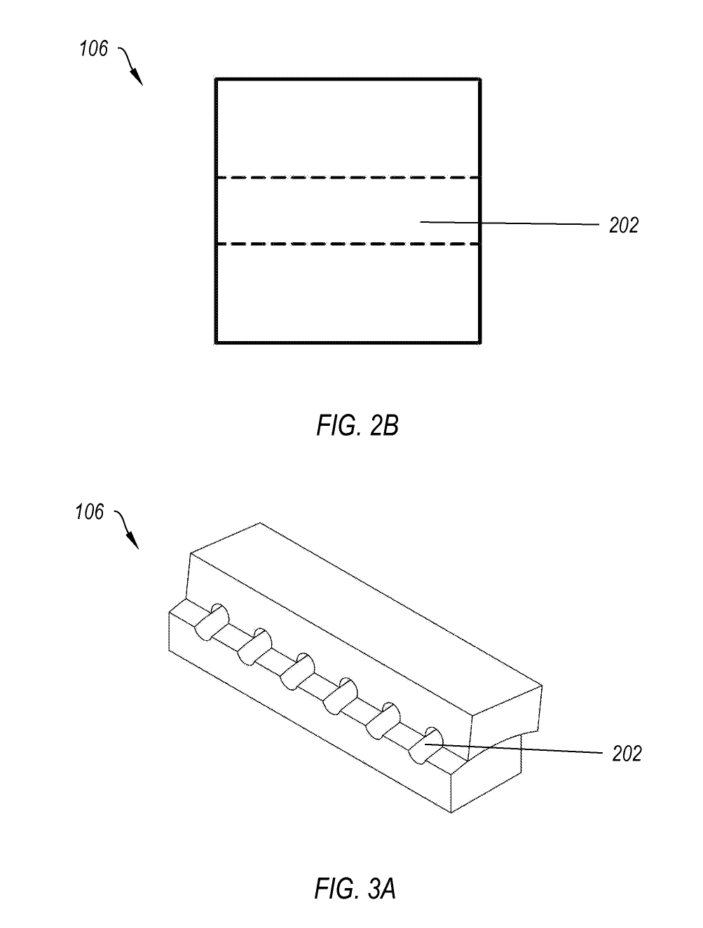

FIGS. 2A and 2B (collectively “FIG. 2”) illustrate an example of an adjustable shear key 106. FIG. 2A illustrates a perspective view of the example of an adjustable shear key 106; and FIG. 2B illustrates a side view of the example of an adjustable shear key 106. The adjustable shear key 106 releasably connects the first element to the second element in a key joint so that when the first element is moved in either direction, the second element will be likewise moved through the adjustable shear key 106. The second element will continue to be driven by the first element so long as the shearing strains do not exceed the shear strength of the adjustable shear key 106. When the force exceeds the shear strength the adjustable shear key 106 will shear or snap or otherwise be broken in two. The shearing of the adjustable shear key 106 severs the driving relation between the first element and second element and relative motion between them may then occur.

FIG. 2 shows that the adjustable shear key 106 includes one or more designed flaws 202. The one or more designed flaws can include any feature that reduces the shear force of the adjustable shear key 106. For example, the one or more designed flaws 202 can include a cut, hole, void, slot (i.e., a depression) or any other flaw. The designed flaws 202 allow a user to determine the exact shear force that will be required to shear the adjustable shear key 106, as described below.

The one or more designed flaws 202 are oriented such that the alignment of the one or more designed flaws is parallel to the transmission of force (e.g., the tangent of the interface of the first element and second element in a rotating keyed joint). For example, if the designed flaw 202 include a hole that passes through the entire adjustable shear key, the axis of the hole can be parallel to the interface of the first element and the second element. If the designed flaw includes a cut, then the cut can be parallel to the interface of the first element and the second element. Additionally or alternatively, the one or more designed flaws 202 allow the predetermined shear limit of the adjustable shear key 106 to be adjusted. I.e., the length, width, diameter of each designed flaw 202 and number of designed flaws 202 can be changed to adjust the predetermined shear limit of the adjustable shear key 106. In particular, the adjustable shear key 106 without the one or more designed flaws 202 requires a certain shear force before the adjustable shear key 106 shears. The one or more designed flaws 202 reduce the shear force to a desired level. This allows the adjustable shear key 106 to shear before the force damages the first element and/or the second element.

By way of example, a user can determine the shear strength by adjusting the size of the designed flaws 202 and the length of the adjustable shear key 106. I.e., for a given length, cross-sectional size and material a shear key will have a certain shear force that is required to shear the shear key. The adjustable shear key 106 may come with a series of designed flaws 202 such that a user can cut the length and adjust the size of the designed flaws 202 (e.g., increasing the diameter of the hole) to create a known desired shear force.

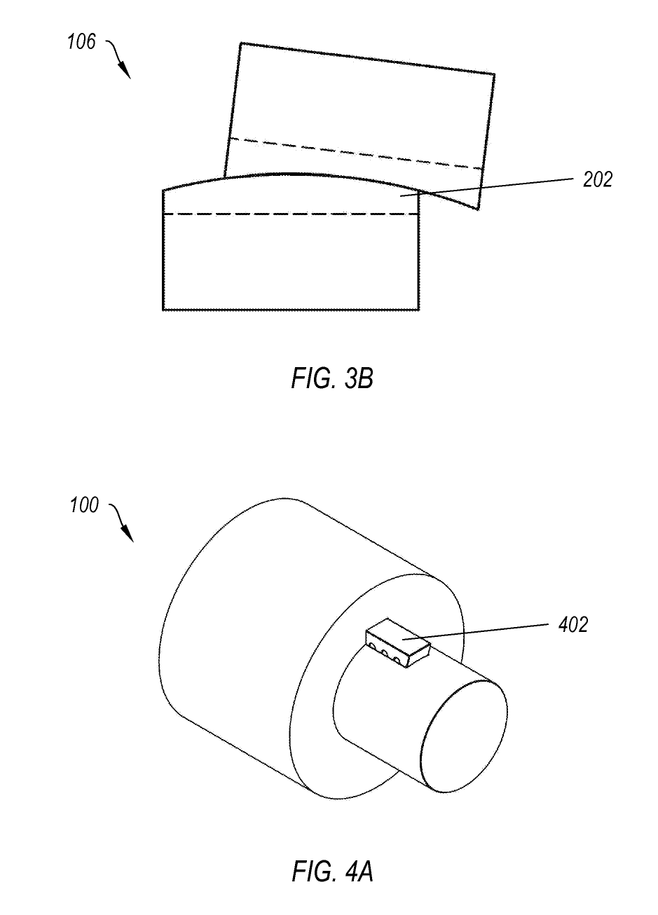

FIGS. 3A and 3B (collectively “FIG. 3”) illustrate an example of an adjustable shear key 106 which has been sheared. FIG. 3A illustrates a perspective view of the example of an adjustable shear key 106 which has been sheared; and FIG. 3B illustrates a side view of the example of an adjustable shear key 106 which has been sheared. When the adjustable shear key 106 has been sheared, force is no longer transmitted from the first element to the second element or vice versa. That is, the first element and the second element may freely move relative to one another.

Shear forces are unaligned forces pushing one part of a body in one direction, and another part of the body in the opposite direction. In the adjustable shear key 106 the force provided by the moving first element is opposite the resistance provided by the second element. If the moving first element is circular, the shear force acts in a direction that is tangent to the interface of the first element (or the imaginary surface—where the surface of the first element would be but for the presence of the keyseat). FIG. 3 shows that at some point in the interface the tangent of the surface of the first element is parallel to the one or more designed flaws 202 in the adjustable shear key 106. Thus, when shear occurs, it occurs along the interface of the first element and the second element which passes through the adjustable shear key 106.

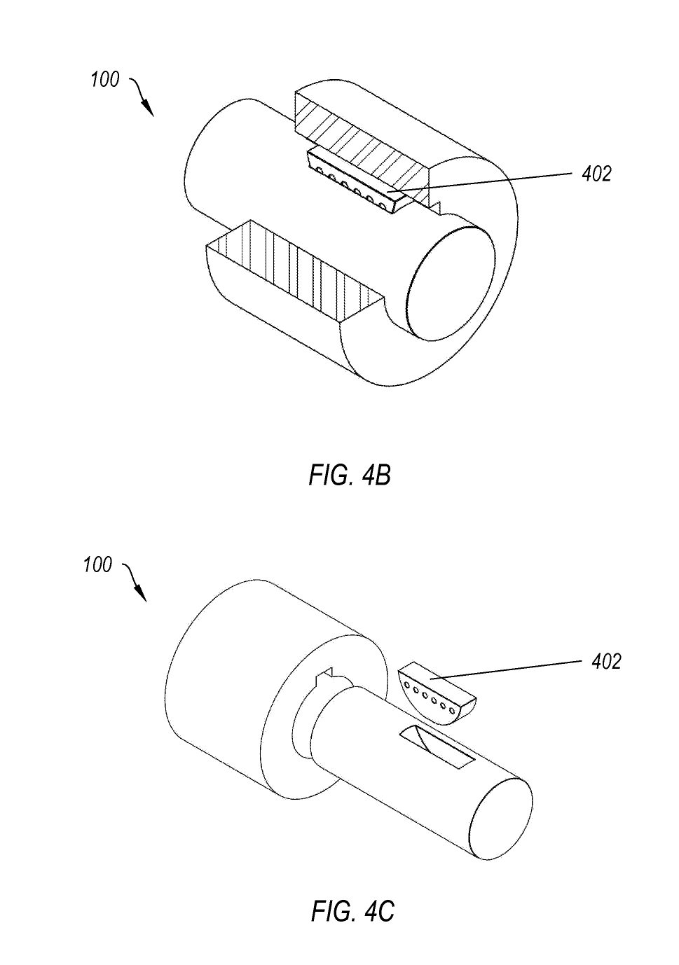

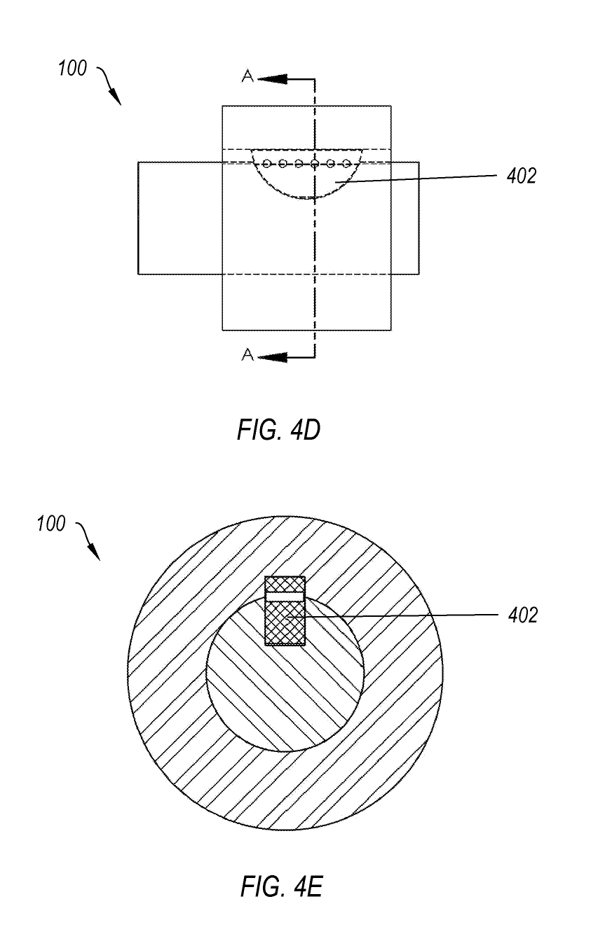

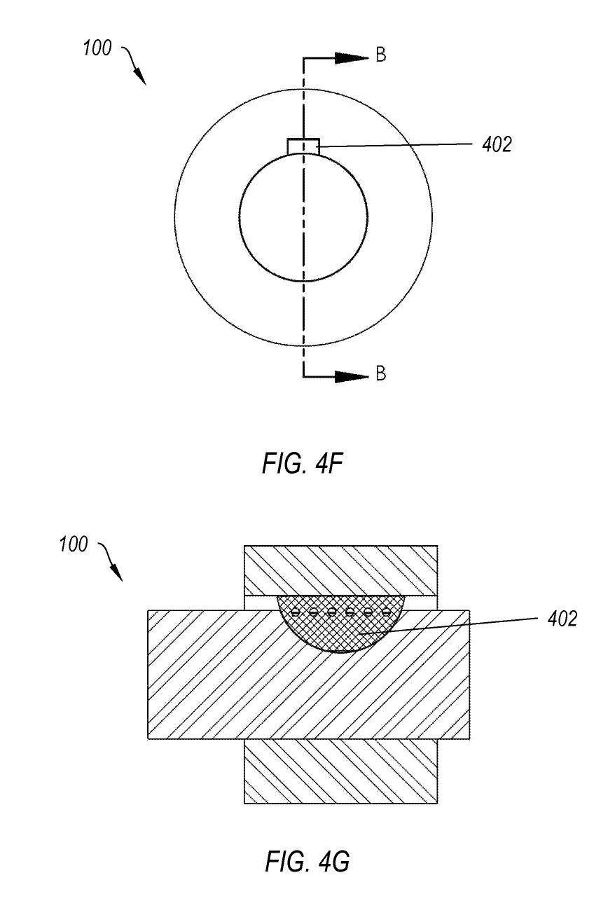

FIGS. 4A-4G (collectively “FIG. 4”) illustrate an alternative example of a keyed joint 100. FIG. 4A is a perspective view of the alternative example of a keyed joint 100; FIG. 4B is a partial cut-away view of the alternative example of a keyed joint 100; FIG. 4C is an exploded view of the alternative example of a keyed joint 100; FIG. 4D is a side view of the alternative example of a keyed joint 100 (with the dashed lines representing hidden edges); FIG. 4E is a cross-section view of the alternative example of a keyed joint 100 along the line A-A of FIG. 4D; FIG. 4F is an end view of the alternative example of a keyed joint 100; and FIG. 4G is a cross-section view of the alternative example of a keyed joint 100 along the line B-B of FIG. 4F. The adjustable shear key of FIG. 4 is an adjustable woodruff key 402. A Woodruff key 402 is semicircular or semiovular shaped, such that, when installed, it leaves a protruding tab. The keyway in the first element is a semi-circular pocket, the mating part, a longitudinal slot. They are used to improve the concentricity of the first element and the mating part, which is critical for high speed operation. The main advantage of the adjustable woodruff key 402 is that it eliminates milling a keyway near first element shoulders, which already have stress concentrations.

Other types of keys that can be used include tapered keys, scotch keys, dutch pins, spline key or hirth joint. A tapered key is tapered only on the side that engages the second element. The keyway in the second element has a taper that matches that of the tapered key. Some taper keys have a gib, or tab, for easier removal during disassembly. The purpose of the taper is to secure the key itself, as well as, to firmly engage the first element to the second element without the need for a set screw. The problem with taper keys is that they can cause the center of the first element motion to be slightly off of the mating part. It is different from a tapered shaft lock in that tapered keys have a matching taper on the keyway, while tapered shaft locks do not. A “scotch key” or “dutch key” also provides a keyway not by milling but by drilling axially into the part and the first element, so that a round key can be used. If the key is tapered, it is referred to as a “dutch pin” and is driven in, and generally cut off flush with the end of the first element. A hirth joint is similar to a spline joint but with the teeth on the butt of the first element instead of on the surface.

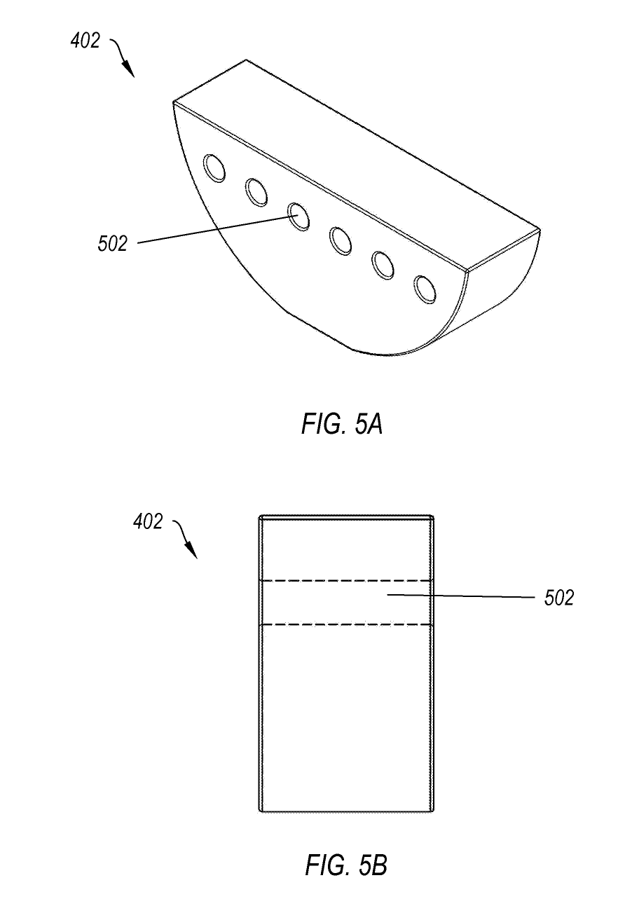

FIGS. 5A and 5B (collectively “FIG. 5”) illustrate an example of an adjustable woodruff key 402. FIG. 5A illustrates a perspective view of the example of an adjustable woodruff key 402; and FIG. 5B illustrates a side view of the example of an adjustable woodruff key 402. The adjustable woodruff key 402 releasably connects the first element to the second element in a key joint so that when the first element is moved in either direction, the second element will be likewise moved through the adjustable woodruff key 402. The second element will continue to be driven by the first element so long as the shearing strains do not exceed the shear strength of the adjustable woodruff key 402. When the force exceeds the shear strength the adjustable woodruff key 402 will shear or snap or otherwise be broken in two. The shearing of the adjustable woodruff key 402 severs the driving relation between the first element and second element and relative motion between them may then occur.

FIG. 5 shows that the adjustable woodruff key 402 includes one or more designed flaws 502. The one or more designed flaws 502 are in the direction of the shear force and allow the predetermined shear limit of the adjustable woodruff key 402 to be adjusted. I.e., the length, width, diameter of each designed flaw 402 and number of designed flaws 502 can be changed to adjust the predetermined shear limit of the adjustable woodruff key 402. In particular, the adjustable woodruff key 402 without the one or more designed flaws 502 requires a certain shear force before the adjustable woodruff key 402 shears. The one or more designed flaws 502 reduces the shear force to a desired level. This allows the adjustable woodruff key 402 to shear before the force damages the first element and/or the second element.

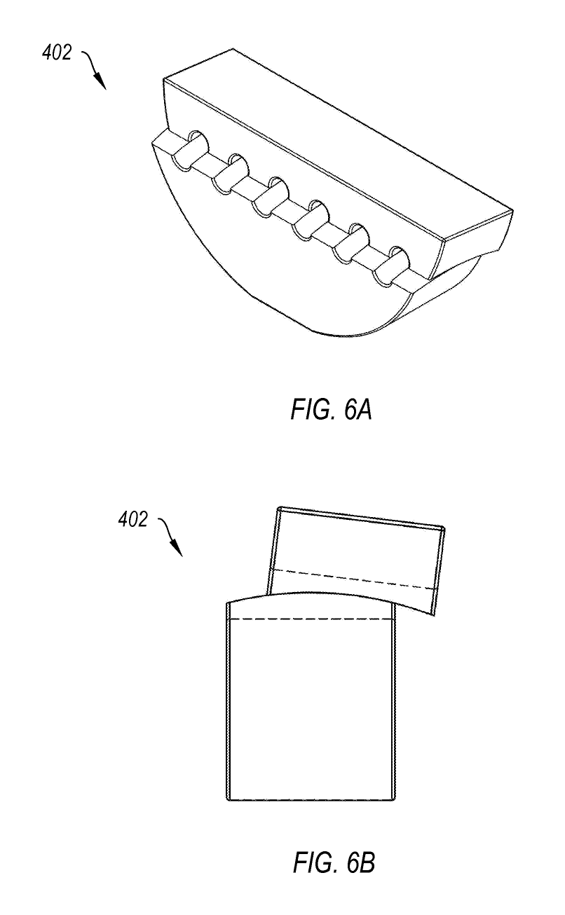

FIGS. 6A and 6B (collectively “FIG. 6”) illustrate an example of an adjustable woodruff key 402 which has been sheared. FIG. 6A illustrates a perspective view of the example of an adjustable woodruff key 402 which has been sheared; and FIG. 6B illustrates a side view of the example of an adjustable woodruff key 402 which has been sheared. When the adjustable woodruff key 402 has been sheared, force is no longer transmitted from the first element to the second element or vice versa. That is, the first element and the second element may freely move relative to one another.

FIG. 6 shows that the adjustable woodruff key 402 shears along the interface of the first element and the second element (which is parallel to the one or more designed flaws 502 in the adjustable woodruff key 402). Thus, when shear occurs, it occurs in along the imaginary surface of the first element which passes through the adjustable woodruff key 402.

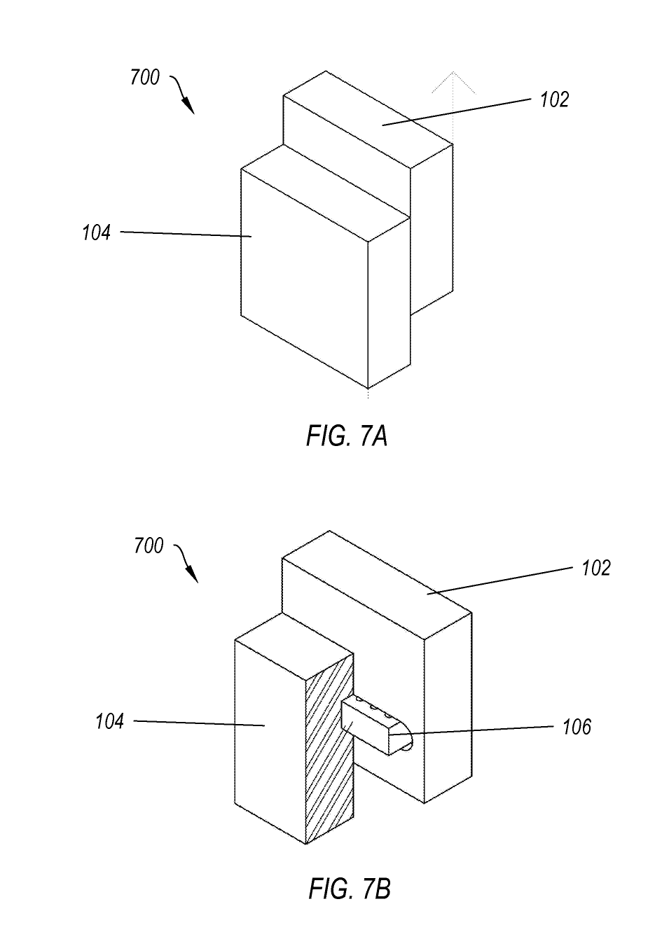

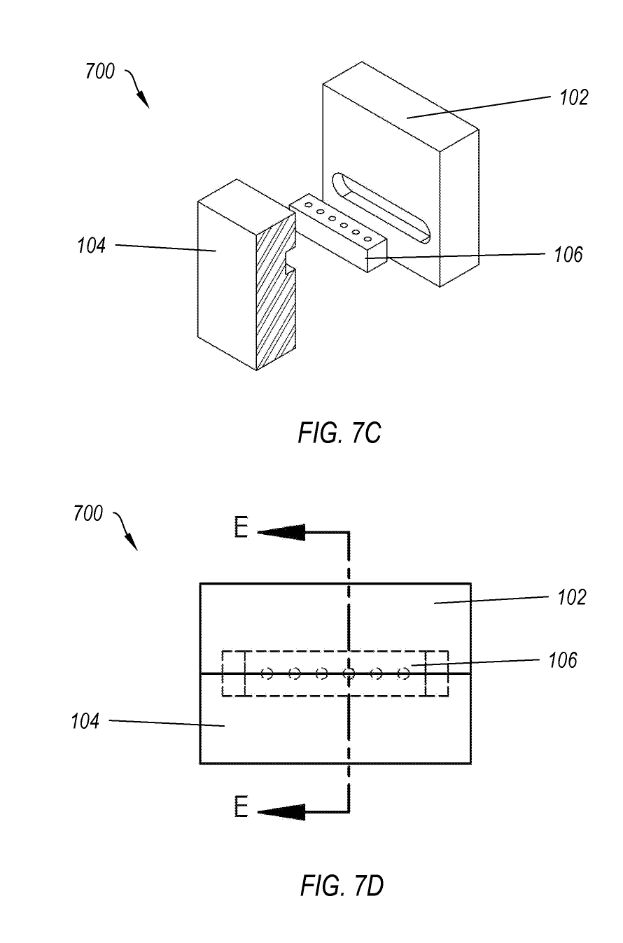

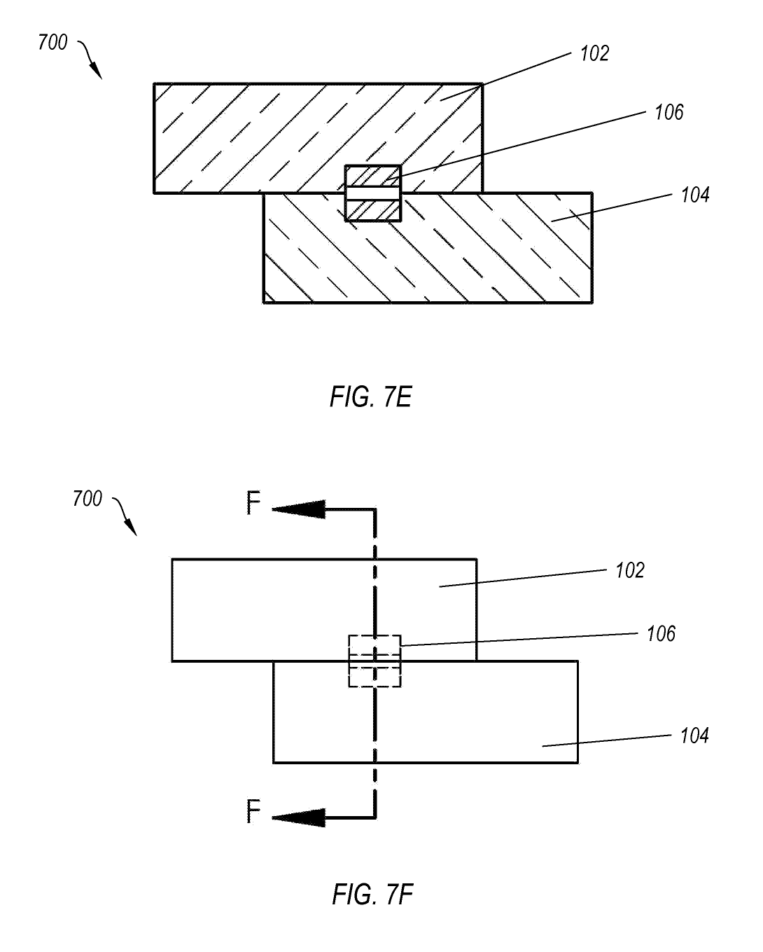

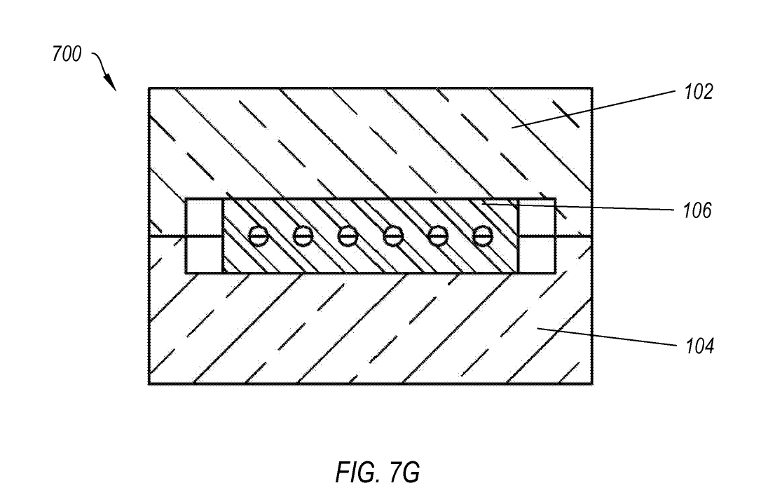

FIGS. 7A-4G (collectively “FIG. 7”) illustrate an example of a planar keyed joint 700. FIG. 7A is a perspective view of the example of a planar keyed joint 700; FIG. 7B is a partial cut-away view of the example of a planar keyed joint 700; FIG. 7C is an exploded view of the example of a planar keyed joint 700; FIG. 7D is a side view of the example of a planar keyed joint 700 (with the dashed lines representing hidden edges); FIG. 7E is a cross-section view of the example of a planar keyed joint 700 along the line E-E of FIG. 7D; FIG. 7F is an end view of the example of a planar keyed joint 700; and FIG. 7G is a cross-section view of the example of a planar keyed joint 700 along the line F-F of FIG. 7F. The planar keyed joint 700 prevents relative lateral motion of the first element 102 and the second element 104. I.e., lateral motion in one direction (shown by the arrows in FIG. 7A) is transmitted from the first element 102 to the second element 104 via the adjustable shear key 106 and vice versa; however motion of the first element relative to the second element perpendicular to the direction of the arrows in FIG. 7A is permitted. I.e., a force perpendicular to the arrows in FIG. 7A could cause motion in the first element that is unmatched by motion in the second element and vice versa.

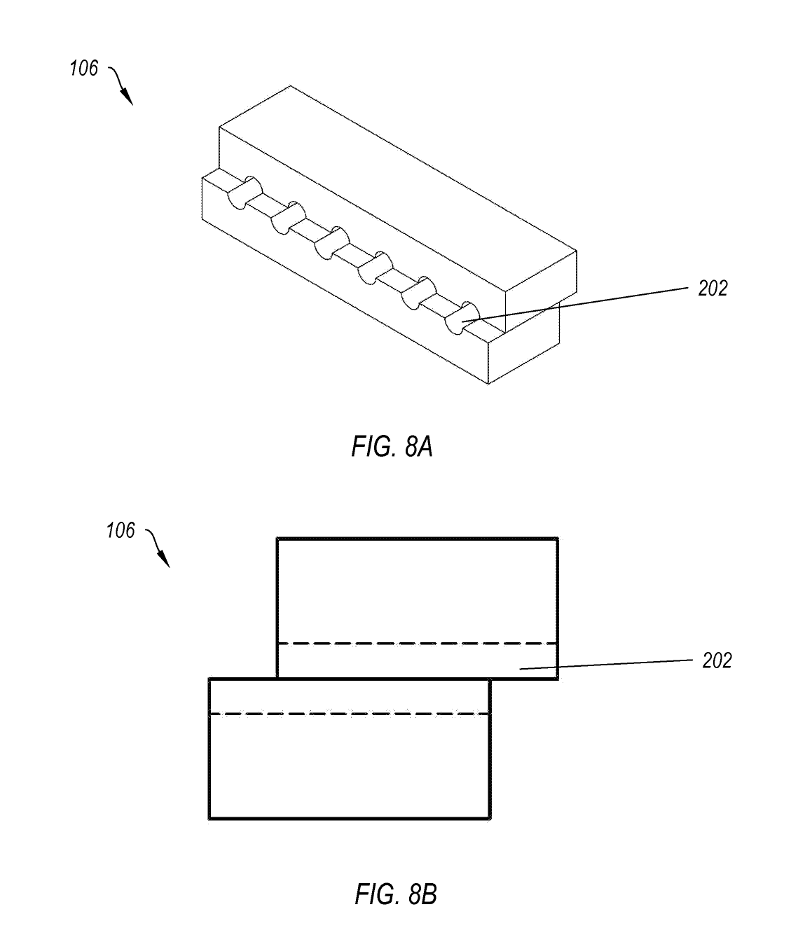

FIGS. 8A and 8B (collectively “FIG. 8”) illustrate an example of an adjustable shear key 106 which has been sheared during use in a planar keyed joint. FIG. 8A illustrates a perspective view of the example of an adjustable shear key 106 which has been sheared during use in a planar keyed joint; and FIG. 8B illustrates a side view of the example of an adjustable shear key 106 which has been sheared during use in a planar keyed joint. When the adjustable shear key 106 has been sheared, force is no longer transmitted from the first element to the second element or vice versa. That is, the first element and the second element may freely move relative to one another.

FIG. 8 shows that the adjustable shear key 106 shears along the interface of the first element and the second element (which is parallel to the one or more designed flaws 202 in the adjustable shear key 106). Thus, when shear occurs, it occurs along the imaginary surface located at the interface of the first element and the second element which passes through series of designed flaw in the adjustable shear key 106.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An adjustable shear key for connecting a first element to a second element, the adjustable shear key comprising:
a body, the body comprising:
a first portion configured to mate with a keyseat in a first element; and
a second portion configured to mate with a keyway in a second element;
wherein the body is configured to prevent relative motion in at least one direction of the first element relative to the second element; and
a designed flaw passing through the body, wherein the alignment of the designed flaw is parallel to the interface of the first element and the second element;
wherein the designed flaw is configured to allow the body to shear at a predetermined shear force.

2. The adjustable shear key of claim 1, wherein the designed flaw includes a hole.

3. The adjustable shear key of claim 1, wherein the designed flaw includes a slot.

4. The adjustable shear key of claim 1, wherein the body is configured to prevent relative lateral movement of the first element relative to the second element.

5. The adjustable shear key of claim 1, wherein the body is configured to prevent relative rotation of the first element relative to the second element.

6. The adjustable shear key of claim 4, wherein the first element includes a shaft.

7. The adjustable shear key of claim 4, wherein the second element includes a rotating element.

8. The adjustable shear key of claim 7, wherein the rotating element includes a gear.

9. The adjustable shear key of claim 1 further comprising a second designed flaw, wherein the second designed flaw is parallel to the first designed flaw.

10. The adjustable shear key of claim 1 further comprising:
a set screw, wherein the set screw is configured to hold the first portion of the body within the keyseat.

11. A keyed joint, the keyed joint comprising:
a first element, wherein the first element includes a keyseat;
a second element, wherein the second element includes a keyway; and
an adjustable shear key for connecting the first element to the second element, the adjustable shear key comprising:
a body, the body comprising:
a first portion configured to mate with the keyseat in the first element; and
a second portion configured to mate with the keyway in the second element;
wherein the body is configured to prevent relative motion of the first element relative to the second element;
a designed flaw passing through the body, wherein the alignment of the designed flaw is parallel to the interface of the first element and the second element;
wherein the designed flaw is configured to allow the body to shear at a predetermined shear force.

12. The keyed joint of claim 11, wherein the adjustable shear key includes a parallel shear key.

13. The keyed joint of claim 12, wherein the parallel shear key includes a square shear key.

14. The keyed joint of claim 12, wherein the parallel shear key includes a rectangular shear key.

15. The keyed joint of claim 11, wherein the adjustable shear key includes a woodruff key.

16. The keyed joint of claim 17, wherein the woodruff key includes a semicircular shear key.

17. The keyed joint of claim 17, wherein the woodruff key includes a semiovular shear key.

18. A keyed joint for, the keyed joint comprising:
a shaft, wherein the shaft includes a keyseat;
a rotating element, wherein the rotating element includes a keyway; and
an adjustable shear key for connecting the shaft to the rotating element, the adjustable shear key comprising:
a body, the body comprising:
a first portion configured to mate with the keyseat in the shaft; and
a second portion configured to mate with the keyway in the rotating element;
wherein the body is configured to prevent relative motion of the shaft relative to the rotating element;
a series of designed flaws passing through the body, wherein the alignment of each of the designed flaws is parallel to the tangent of the interface of the shaft and the rotating element;
wherein the series of designed flaws is configured to allow the body to shear at a predetermined shear force.

19. The keyed joint of claim 18 further comprising:
a second adjustable shear key for connecting the shaft to the rotating element, the second adjustable shear key comprising:
a body, the body comprising:
a first portion configured to mate with the keyseat in the shaft; and
a second portion configured to mate with the keyway in the rotating element;
wherein the body is configured to prevent relative motion of the shaft relative to the rotating element;
a series of designed flaws passing through the body, wherein the alignment of each of the designed flaws is parallel to the tangent of the interface of the shaft and the rotating element;
wherein the series of designed flaws is configured to allow the body to shear at a predetermined shear force.

20. The keyed joint of claim 19 further comprising:
a third adjustable shear key for connecting the shaft to the rotating element, the third adjustable shear key comprising:
a body, the body comprising:
a first portion configured to mate with the keyseat in the shaft; and
a second portion configured to mate with the keyway in the rotating element;
wherein the body is configured to prevent relative motion of the shaft relative to the rotating element;
a series of designed flaws passing through the body, wherein the alignment of each of the designed flaws is parallel to the tangent of the interface of the shaft and the rotating element;
wherein the series of designed flaws is configured to allow the body to shear at a predetermined shear force.
